(19) United States
(12) Patent Application Publication
(10) Pub. No.: US 2025/0183821 A1
(43) Pub. Date: Jun. 5, 2025

(54) MOTOR CONTROL DEVICE

(71) Applicant: JTEKT CORPORATION, Kariya-shi, Aichi-ken (JP)

(72) Inventors: Terutaka TAMAIZUMI, Okazaki-shi (JP); Yufeng LIN, Iwata-shi (JP); Yuki INDEN, Okazaki-shi (JP); Muhammad Iqmal ABD RAHIM, Okazaki-shi (JP); Atsuo SAKAI, Okazaki-shi (JP); Hidenori ITAMOTO, Tajimi-shi (JP); Shunsuke TSUJII, Okazaki-shi (JP)

(73) Assignee: JTEKT CORPORATION, Kariya-shi, Aichi-ken (JP)

(21) Appl. No.: 18/843,405

(22) PCT Filed: Mar. 16, 2022
(86) PCT No.: PCT/JP2022/012011

§ 371 Date: Sep. 3, 2024

(51) Int. Cl. H02P 6/10; B62D 5/04

(52) U.S. Cl. CPC H02P 6/10; B62D 5/046

(57) ABSTRACT

A motor control device includes a command value calculation unit that calculates a command value for controlling a motor, and a disturbance observer unit for estimating a disturbance applied to a mechanical device, based on the command value and rotation information of the motor, and to correct the command value based on the disturbance that is estimated. The disturbance observer unit has parameters that are adjusted to compensate for effects of the disturbance having a specific frequency that is an object of suppression. The parameters are adjusted such that a disturbance, applied to the mechanical device after effects of the disturbance are compensated for, has frequency characteristics corresponding to antiresonance characteristics of the mechanical device. The disturbance observer unit is configured to change the values of the parameters in accordance with the rotation information of the motor.

### TECHNICAL FIELD

The present invention relates to a motor control device.

### BACKGROUND ART

There conventionally is an electric power steering system. The electric power steering system (hereinafter referred to as “EPS”) assists steering by a steering wheel, by applying torque from a motor to a steering mechanism. A control device of the EPS calculates a target current value according to steering torque applied to the steering wheel, and controls power feeding to the motor, based on the target current value that is calculated. Thus, the motor generates torque corresponding to the steering torque.

In EPSs, vibrations generated due to torque ripple of the motor or reduction gear are readily conveyed to the steering wheel. Accordingly, torque differential control, such as described in Patent Document 1, for example, is performed. The control device calculates a torque differential value by differentiation of the steering torque detected by a torque sensor, and corrects the target current value in accordance with the torque differential value that is calculated. This suppresses vibrations due to torque ripple.

### RELATED ART DOCUMENTS

### Patent Documents

Patent Document 1: Japanese Unexamined Patent Application Publication No. 2004-224129 (JP 2004-224129 A)

### SUMMARY OF THE INVENTION

### Problem to be Solved by the Invention

Executing torque differential control certainly does enable suppression of vibrations due to torque ripple. However, torque differential control may not be able to suppress vibrations due to torque ripple to a required level. Accordingly, there is demand to more appropriately suppress vibrations due to torque ripple. Also, motors are used as drive sources not only for electric power steering systems but also for various types of mechanical devices. There also is demand to reduce vibrations due to torque ripple in the motors of these mechanical devices as well.

### Means for Solving the Problem

A motor control device according to an aspect of the present disclosure controls a motor of a mechanical device. The motor control device includes a command value calculation unit configured to calculate a command value for controlling the motor, and a disturbance observer unit configured to estimate a disturbance applied to the mechanical device, based on the command value and rotation information of the motor, and to correct the command value based on the disturbance that is estimated. The disturbance observer unit has a parameter that is adjusted to compensate for effects of the disturbance having a specific frequency that is an object of suppression. The disturbance that is applied to the mechanical device, after the effects of the disturbance have been compensated for, is a post-compensation disturbance, the parameter is adjusted such that the disturbance following compensation of the disturbance has frequency characteristics corresponding to antiresonance characteristics of the mechanical device. The disturbance observer unit is configured to change a value of the parameter in accordance with the rotation information of the motor.

### BRIEF DESCRIPTION OF THE DRAWINGS

FIG. 1 is a configuration diagram of an embodiment of a motor control device.

FIG. 2 is a block diagram of the motor control device in FIG. 1.

FIG. 3 is a graph showing frequency characteristics of disturbance.

### MODES FOR CARRYING OUT THE INVENTION

### First Embodiment

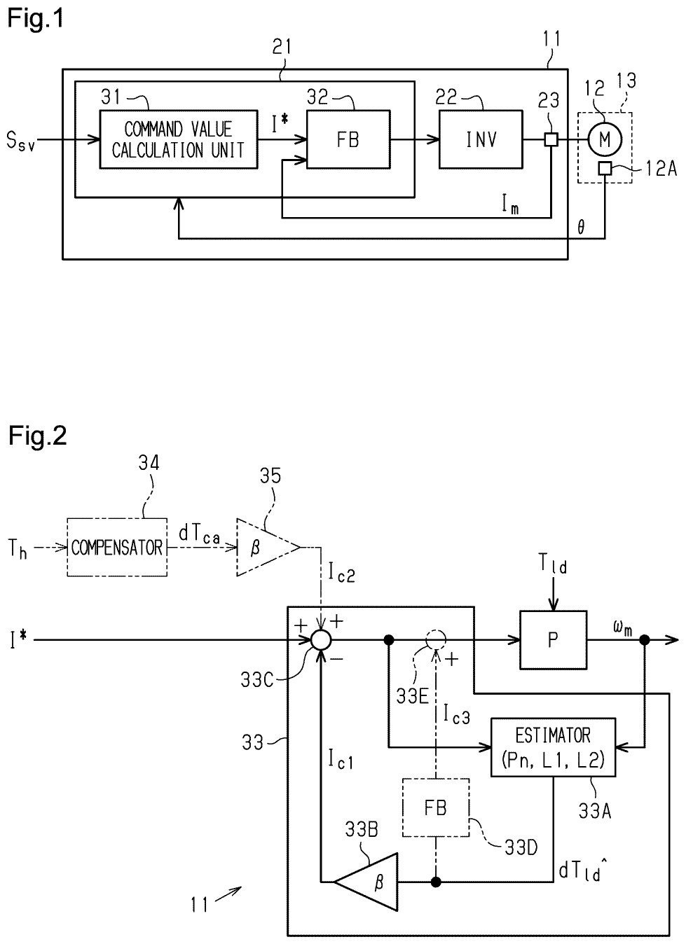

A motor control device 11 according to a first embodiment will be described. As illustrated in FIG. 1, the motor control device 11 controls a motor 12. The motor 12 generates torque for driving a mechanical device 13 in which the motor 12 is to be installed. The motor 12 is, for example, a three-phase brushless motor. The motor 12 has a rotation angle sensor 12A. The rotation angle sensor 12A detects a rotation angle θ of the motor 12. The rotation angle θ of the motor 12 is rotation information of the motor 12.

The motor control device 11 has a microcomputer 21, an inverter 22, and a current sensor 23. The microcomputer 21, which is a processing circuit, has a command value calculation unit 31 and a feedback calculation unit 32. These calculation units are functional parts realized by a CPU (central processing unit) of the microcomputer 21 executing a control program. The microcomputer 21 includes memory that stores the control program. The memory includes computer-readable media such as RAM (Random Access Memory) and ROM (Read Only Memory). However, each calculation unit being realized by software is only an example, and at least part of the calculation units may be realized by a hardware circuit such as a logic circuit.

The command value calculation unit 31 calculates a current command value I* for the motor 12 based on a state variable S_{SV} indicating a state of the mechanical device 13, for example. The feedback calculation unit 32 calculates a difference between the current command value I* calculated by the command value calculation unit 31 and a value of a current Im of the motor 12 detected by way of the current sensor 23. The feedback calculation unit 32 generates a drive signal for the inverter 22 so as to eliminate the difference between the current command value I* and the value of the current Im of the motor 12.

The inverter 22 operates based on the drive signal generated by the feedback calculation unit 32. The inverter 22 has a plurality of switching elements. By switching these switching elements based on the drive signal, electric power in accordance with the current command value I* is generated. The electric power generated by the inverter 22 is supplied to the motor 12 via a power supply path made up of a bus bar, a cable, or the like. Thus, the motor 12 generates torque corresponding to the current command value I*.

### <Disturbance Observer>

As illustrated in the block diagram of FIG. 2, the motor control device 11 has a disturbance observer unit 33. The disturbance observer unit 33 is provided to estimate a disturbance T_{ld} that is applied to a plant P, which is an object of control, and to compensate for effects of the disturbance T_{ld}. Compensation for the effects of disturbance refers to reducing the effects of disturbance by taking into account characteristics of the disturbance when controlling a system that is subject to disturbance. The disturbance T_{ld} is nonlinear torque. The disturbance T_{ld} is, for example, torque ripple of the motor 12. Torque ripple is a disturbance that occurs periodically as the motor 12 rotates.

A control system for the motor 12 is a feedback control system that determines the current command value I* for the motor 12 based on the state variable S_{SV} of the mechanical device 13. Supplying current from the inverter 22 to the motor 12 in accordance with the current command value I* rotates the motor 12 at a predetermined angular velocity ωₘ. Accordingly, a range from the current command value I* for the motor 12, to the angular velocity ωₘ of the motor 12, is an object of control in the feedback control system. The angular velocity ωₘ of the motor 12 is the rotation information of the motor 12. The plant P includes the mechanical device 13.

In a case in which an inertial number of the mechanical device 13 is “1”, and the mechanical device 13 and the motor 12 are regarded as being connected via an elastic element, the object of control can be regarded as being a two-inertial system in which two moments of inertia are connected by the elastic element. In this case, the object of control has frequency characteristics that include one set of resonance characteristics and antiresonance characteristics.

Also, in a case in which the inertial number of the mechanical device 13 is “2”, and the mechanical device 13 and the motor 12 are regarded as being connected via an elastic element, the object of control can be regarded as being a three-inertial system in which three moments of inertia are connected by the elastic element. In this case, the object of control has frequency characteristics that include two sets of resonance characteristics and antiresonance characteristics.

The disturbance observer unit 33 takes in the current command value I*, which is a target value of the plant P, and output of the plant P. An example of the output of the plant P is the angular velocity ωₘ of the motor 12. The angular velocity ωₘ is obtained by differentiation of the rotation angle θ of the motor 12 that is detected by the rotation angle sensor 12A. The disturbance observer unit 33 estimates the disturbance T_{ld} based on the current command value I* and the angular velocity ωₘ of the motor 12. The disturbance observer unit 33 calculates a first correction value I_{c1} for canceling out the disturbance T_{ld} having a frequency that is an object of suppression.

The disturbance observer unit 33 has an estimator 33A, a multiplier 33B, and a subtractor 33C. The disturbance observer unit 33 may be made up of a hardware circuit, such as a logic circuit. The disturbance observer unit 33 is also referred to as a disturbance observer circuit. Also, the disturbance observer unit 33 may be a functional part realized by a CPU of a computer executing a control program.

The estimator 33A has a nominal plant Pn, a first observer gain L1, and a second observer gain L2. The nominal plant Pn is a model simulating the plant P that is the object of control. The estimator 33A calculates difference Δω between the angular velocity ωₘ of the motor 12 obtained as the output of the plant P and estimated angular velocity ωₘ\hat{ } of the motor 12 obtained as output of the nominal plant Pn, as shown in the following Expression (1). “\hat{ }” indicates an estimated value.

$$Δω = {ω}_{m} - {ω}_{m} ⋀ \qquad ( 1 )$$

The estimator 33A multiplies the value of the difference Δω between the angular velocity ωₘ of the motor 12 and the estimated angular velocity ωₘ\hat{ } of the motor 12 by the second observer gain L2, as shown in the following Expression (2), thereby calculating a differential value dT_{ld}\hat{ } of an estimated disturbance T_{ld}\hat{ }.

$$d {T}_{ld} ⋀ = Δ ω \cdot L 2 \qquad ( 2 )$$

Note that the estimator 33A calculates the estimated disturbance T_{ld}\hat{ } by integration of the differential value dT_{ld}\hat{ } of the estimated disturbance T_{ld}\hat{ }. The nominal plant Pn calculates an estimated value ωₘ\hat{ } of the angular velocity ωₘ using the estimated disturbance T_{ld}\hat{ }, a value obtained by multiplying the value of the difference Δω by the first observer gain L1, and a viscosity coefficient C of the motor 12.

The multiplier 33B calculates the first correction value I_{c1} by multiplying the differential value dT_{ld}\hat{ } of the estimated disturbance T_{ld}\hat{ } calculated by the estimator 33A, by a gain β. The first correction value I_{c1} is a current value for canceling out vibration due to the disturbance T_{ld}.

The subtractor 33C subtracts the first correction value I_{c1} from the current command value I* to calculate a current command value I* in which the effects of the disturbance T_{ld} have been compensated for. The disturbance T_{ld} that is applied to the mechanical device 13 after the effects of the disturbance T_{ld} have been compensated for by the disturbance observer unit 33 is referred to as post-compensation disturbance Tₗₐₛₜ.

The post-compensation disturbance Tₗₐₛₜ is expressed by the following Expression (3).

$${T}_{l a s t} = {T}_{ld} - β \cdot {dT}_{ld} ⋀ = \text{} \{ {Js}^{2} + ( - L 2 \cdot β + L 1 \cdot J ) s + L 2 \} \cdot {T}_{l d} \text{} / \{ {Js}^{2} + ( - L 2 \cdot C + L 1 \cdot J ) s \text{} + L 2 \} \cdot Js \qquad ( 3 )$$

where “J” is a coefficient of inertia in which a moment of inertia of the mechanical device 13 is modeled. “C” is a viscosity coefficient that models the friction of the mechanical device 13. “s” is a Laplace operator. “L1” is the first observer gain. “L2” is the second observer gain. “β” is gain.

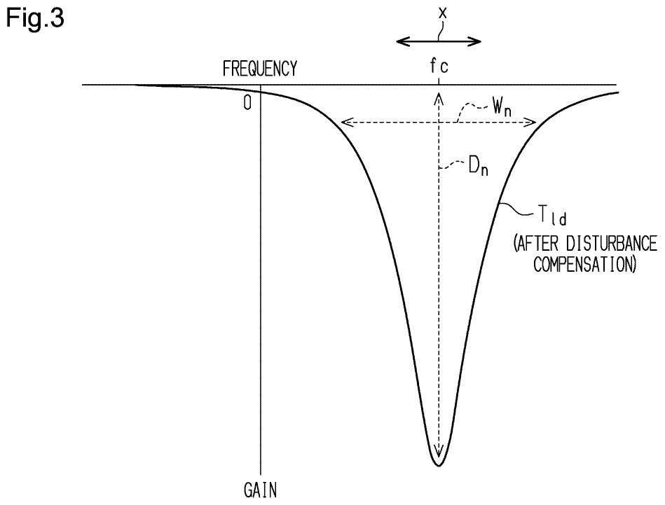

As shown in the graph of FIG. 3, the post-compensation disturbance Tₗₐₛₜ has a notch, which is a spike-like drop, in frequency characteristics thereof. The post-compensation disturbance Tₗₐₛₜ has frequency characteristics corresponding to the antiresonance characteristics of the plant P.

The first observer gain L1 is expressed by the following Expression (4).

$$L 1 = 2 \cdot ω \cdot α \qquad ( 4 )$$

where “ω” is frequency. “α” is a first parameter.

The second observer gain L2 is expressed by the following Expression (5).

$$L 2 = J \cdot {ω}^{2} \qquad ( 5 )$$

where “J” is the coefficient of inertia in which the moment of inertia of the mechanical device 13 is modeled. “ω” is frequency.

The gain β is expressed by the following Expression (6).

$$β = α / ω \cdot 2 \cdot γ \qquad ( 6 )$$

where “α” is a first parameter, “ω” is frequency, and “γ” is a second parameter. The second parameter γ is a value of “1” or less, and can be set, for example, in steps of “0.1”.

A value of frequency ω is set to the frequency of the disturbance T_{ld} to be suppressed. The frequency of the disturbance T_{ld} to be suppressed is, for example, a center frequency f_{c} of a notch in the disturbance T_{ld}.

Further, adjusting the value of the first observer gain L1 enables a width Wₙ of the notch in the disturbance T_{ld} to be adjusted. Adjusting the value of the first parameter α in Expression (4) enables the value of the first observer gain L1 to be adjusted.

Also, adjusting the value of the gain β enables a depth Dₙ of the notch in the disturbance T_{ld} to be adjusted. Adjusting the value of the second parameter γ in Expression (6) enables the value of the gain β to be adjusted.

The first observer gain L1 and the gain β are parameters that are adjusted to suppress vibrations due to the disturbance T_{ld} having a specific frequency that is the object of suppression. Adjusting the value of the first observer gain L1 and the value of the gain β enables a conveyance rate of the disturbance T_{ld} to the plant P to be adjusted. The value of the first observer gain L1 and the value of the gain β are adjusted so that the post-compensation disturbance Tₗₐₛₜ has frequency characteristics corresponding to the antiresonance characteristics of the plant P. Inputting the post-compensation disturbance Tₗₐₛₜ having frequency characteristics corresponding to the antiresonance characteristics of the plant P into the plant P theoretically enables amplitude of vibrations of the mechanical device 13 due to the disturbance T_{ld} having the specific frequency that is the object of suppression to be set to “0”.

Substituting Expressions (4), (5), and (6) into the above Expression (3) yields the following Expression (7).

$${T}_{l a s t} = \{ {s}^{2} + 2 \cdot ω \cdot α \cdot ( 1 - γ ) \cdot s + {ω}^{2} \} \cdot {T}_{l d} / \{ {s}^{2} + 2 \cdot ω \cdot α \cdot s + {ω}^{2} \} \qquad ( 7 )$$

When the value of the second term “2·ω·α·(1−γ)·s” in the curly brackets in the numerator of Expression (7) is “0”, the conveyance rate of the disturbance T_{ld} having the specific frequency that is the object of suppression with respect to the plant P becomes “0”. Accordingly, setting the value of the second parameter γ to “1” enables the vibrations due to the disturbance T_{ld} having the specific frequency that is the object of suppression to be cancelled out. Also, adjusting the value of the second parameter γ between “0 to 1” in steps of “0.1”, for example, enables the conveyance rate of the disturbance T_{ld} having the specific frequency that is the object of suppression with respect to the plant P to be adjusted. The smaller the value of the second term “2·ω·α·(1−γ)·s” in the curly brackets in the numerator of Expression (7) becomes, the smaller the conveyance rate of the disturbance T_{ld} having the specific frequency that is the object of suppression with respect to the plant P becomes.

Note that the second term in the curly brackets in the numerator of Expression (7), “2·ω·α·(1−γ)·s”, corresponds to the second term in the curly brackets in the numerator of Expression (3), “(−L2·β+L1·J) s”. To adjust the value of the second parameter γ is also to adjust the value of the gain β.

### <Change in Frequency of Disturbance T_{ld}>

The motor control device 11 can compensate for effects of disturbance T_{ld} having a particular frequency. However, there are the following concerns regarding the motor control device 11.

That is to say, change in the angular velocity ωₘ of the motor 12 may cause change in the frequency of the disturbance T_{ld}. Accordingly, in a case in which parameter values of the disturbance observer unit 33 are fixed to values specific to a particular frequency, there is a concern that the effects of the disturbance T_{ld} cannot be compensated for as appropriate. The parameters are the gain β, the first observer gain L1, and the second observer gain L2.

Accordingly, the disturbance observer unit 33 changes the value of the gain β, the value of the first observer gain L1, and the value of the second observer gain L2, in accordance with the change in the angular velocity ωₘ of the motor 12, and hence in accordance with the change in the frequency of the disturbance T_{ld}. In this case, the gain β is expressed by the following Expression (8). The first observer gain L1 is expressed by the following Expression (9). The second observer gain L2 is expressed by the following Expression (10).

$$β = α / ω ( t ) \cdot 2 \cdot γ \qquad ( 8 )$$

$$L 1 = 2 \cdot ω ( t ) \cdot α \qquad ( 9 )$$

$$L 2 = J \cdot {ω ( t )}^{2} \qquad ( 10 )$$

where “t” is time. “ω(t)” is the frequency at time t, which may vary over time. “α” is the first parameter. “γ” is the second parameter. “J” is the coefficient of inertia in which the moment of inertia of the mechanical device 13 is modeled.

The following can be understood from Expression (8) to Expression (10). That is to say, change in the angular velocity ωₘ of the motor 12 causes change in the value of the frequency ω(t). When the value of the frequency ω(t) changes, the value of the gain β, the value of the first observer gain L1, and the value of the second observer gain L2 change in accordance with the change. In this way, the values of the parameters (β, L1, L2) of the disturbance observer unit 33 change in accordance with the change in the angular velocity ωₘ of the motor 12.

The disturbance observer unit 33 has a function of calculating the frequency of the disturbance T_{ld} based on the angular velocity ωₘ of the motor 12. There is a correlative relation between the angular velocity ωₘ of the motor 12 and the frequency of the disturbance T_{ld}. The disturbance observer unit 33 calculates the frequency of the disturbance T_{ld} corresponding to the angular velocity ωₘ of the motor 12 based on the correlative relation between the angular velocity ωₘ of the motor 12 and the frequency of the disturbance T_{ld}. The disturbance observer unit 33 stores, for example, a map that defines the relation between the angular velocity ωₘ of the motor 12 and the frequency of the disturbance T_{ld}. The disturbance observer unit 33 uses the map to calculate the frequency of the disturbance T_{ld} corresponding to the angular velocity ωₘ of the motor 12.

The estimator 33A uses the frequency of the disturbance T_{ld}, which is calculated, to set the value of the first observer gain L1 and the value of the second observer gain L2. The estimator 33A calculates the differential value dT_{ld}\hat{ } of the estimated disturbance T_{ld}\hat{ } by using the first observer gain L1 and the second observer gain L2 having values according to the frequency of the disturbance T_{ld} that is calculated.

The multiplier 33B sets the value of the gain β using the frequency of the disturbance T_{ld} that is calculated. The multiplier 33B multiplies the differential value dT_{ld}\hat{ } of the estimated disturbance T_{ld}\hat{ } calculated by the estimator 33A by gain β having a value in accordance with the frequency of the disturbance T_{ld} that is calculated, thereby calculating the first correction value I_{c1}.

In this way, the disturbance observer unit 33 calculates the frequency of the disturbance T_{ld} which changes in accordance with the change in the angular velocity ωₘ of the motor 12. Also, the disturbance observer unit 33 changes the value of the gain β, the value of the first observer gain L1, and the value of the second observer gain L2 in accordance with the change in the frequency of the disturbance T_{ld}. This enables compensation for the effects of the disturbance T_{ld} over a broader frequency range. That is to say, as indicated by the arrow X in the graph in FIG. 3, even when the center frequency f_{c} of the disturbance T_{ld} to be eliminated fluctuates, the disturbance T_{ld} having the center frequency f_{c} that is fluctuating can be eliminated with pinpoint precision.

However, in a case in which the parameter values of the disturbance observer unit 33 are changed in accordance with change in the frequency of the disturbance T_{ld}, a situation may arise in which other concerns than the disturbance T_{ld} arise. This situation is, for example, a situation in which the angular velocity ωₘ of the motor 12 is slower and the amount of change in the angular velocity ωₘ of the motor 12 per unit time is greater. Under this situation, there is concern that torque fluctuations of the motor 12 other than those suppressing the disturbance T_{ld} will occur, due to changing the parameter values of the disturbance observer unit 33 in accordance with change in the frequency of the disturbance T_{ld}.

Accordingly, in order to suppress torque fluctuations of the motor 12 due to change in the parameter values of the disturbance observer unit 33 in accordance with change in the frequency of the disturbance T_{ld}, the first observer gain L1 may be set as in the following Expression (11).

$$L 1 = 2 \cdot ω ( t ) \cdot α - ( d ω ( t ) / dt ) / ω ( t ) \qquad ( 11 )$$

The second term on the right side of Expression (11), which is “(dω(t)/dt)/ω(t)”, is a correction term for the first observer gain L1. The correction term is set based on the perspective of suppressing torque fluctuation of the motor 12 due to change in the parameter value of the disturbance observer unit 33 in accordance with change in the frequency of the disturbance T_{ld}. When the frequency of the disturbance T_{ld} does not change, i.e., when the angular velocity ωₘ of the motor 12 is constant, the value of the correction term is “0”. When the frequency of the disturbance T_{ld} changes, i.e., when the angular velocity ωₘ of the motor 12 changes, the correction term becomes a value other than “0”, thereby correcting the value of the first observer gain L1.

In this way, the disturbance observer unit 33 corrects the value of the first observer gain L1 in accordance with change in the frequency of the disturbance T_{ld} in conjunction with change in the angular velocity ωₘ of the motor 12. This enables torque fluctuation of the motor 12 other than for suppressing the disturbance T_{ld}, due to changing the parameter values of the disturbance observer unit 33 in accordance with change in the frequency of the disturbance T_{ld}, to be suppressed. Accordingly, even when the parameter values of the disturbance observer unit 33 are changed in accordance with change in the frequency of the disturbance T_{ld}, the effects of the disturbance T_{ld} can be compensated for as appropriate.

### <Effects of First Embodiment>

The first embodiment has the following effects.

(1-1) The disturbance observer unit 33 estimates the disturbance T_{ld} using the nominal plant Pn that is a model simulating the plant P, and corrects the current command value I* based on the disturbance T_{ld} that is estimated. The disturbance observer unit 33 has parameters that are adjusted to suppress vibrations due to the disturbance T_{ld} having the specific frequency that is the object of suppression. Adjusting these parameters enables compensating just for the effects of the disturbance T_{ld} having the specific frequency that is the object of suppression. The parameters are adjusted such that the post-compensation disturbance Tₗₐₛₜ has frequency characteristics corresponding to the antiresonance characteristics of the plant P. Inputting the post-compensation disturbance Tₗₐₛₜ that has frequency characteristics corresponding to the antiresonance characteristics of the plant P to the plant P enables vibrations occurring in the plant P to be suppressed or to be canceled out.

(1-2) The disturbance observer unit 33 estimates the disturbance T_{ld} applied to the mechanical device 13 based on the current command value I* and the angular velocity ωₘ of the motor 12. Unlike in the case in which the rotation angle θ of the motor 12 is used, there is no need to calculate the midpoint of the motor 12. The midpoint of the motor 12 is the rotation angle θ of the motor 12 corresponding to the reference operating state of the mechanical device 13. Accordingly, the motor control device 11 does not need to have a function of calculating the midpoint of the motor 12.

(1-3) The disturbance observer unit 33 calculates the first correction value I_{c1} for the current command value I* by multiplying the differential value dT_{ld}\hat{ } of the estimated disturbance T_{ld}\hat{ } by the gain β. Multiplying the differential value dT_{ld}\hat{ } by the gain β is all that is necessary, and accordingly the first correction value I_{c1} can be easily calculated.

(1-4) The post-compensation disturbance Tₗₐₛₜ that is applied to the plant P after the effects of the disturbance T_{ld} have been compensated for has conveyance characteristics expressed by the following Expression (A). This is based on Expression (3) above.

$$\{ J {s}^{2} + ( - L 2 \cdot β + L 1 \cdot J ) s + L 2 \} / \{ {Js}^{2} + ( - L 2 \cdot C + L 1 \cdot J ) s + L 2 \} \cdot Js \qquad ( A )$$

When the value of the second term “(−L2·β+L1·J) s” in the numerator of Expression (A) is “0”, the conveyance rate of the disturbance T_{ld} to the plant P theoretically becomes “0”. Accordingly, the value of the gain β of the disturbance observer unit 33 is adjusted such that the value of the second term of the numerator of Expression (A) becomes “0” or a value closer to “0”. Adjusting the value of the gain β enables the disturbance T_{ld} to be suppressed more appropriately.

(1-5) The disturbance observer unit 33 changes the value of the gain β, the value of the first observer gain L1, and the value of the second observer gain L2, in accordance with the change in the angular velocity ωₘ of the motor 12, and hence in accordance with the change in the frequency of the disturbance T_{ld}. This enables compensation for the effects of the disturbance T_{ld} over a broader frequency range. That is to say, even when the center frequency f of the disturbance T_{ld} to be eliminated fluctuates, the disturbance T_{ld} having the center frequency f_{c} that is fluctuating can be eliminated with pinpoint precision.

(1-6) When the angular velocity ωₘ of the motor 12 changes, the disturbance observer unit 33 corrects the value of the first observer gain L1 in order to suppress torque fluctuations of the motor 12 due to change in the parameter values. The disturbance observer unit 33 corrects the value of the first observer gain L1 in accordance with change in the frequency of the disturbance T_{ld} in conjunction with change in the angular velocity ωₘ of the motor 12. This enables torque fluctuation of the motor 12 other than for suppressing the disturbance T_{ld}, due to changing the parameter values of the disturbance observer unit 33 in accordance with change in the frequency of the disturbance T_{ld}, to be suppressed. Accordingly, even when the parameter values of the disturbance observer unit 33 are changed in accordance with change in the frequency of the disturbance T_{ld}, the effects of the disturbance T_{ld} can be compensated for as appropriate.

### Second Embodiment

The motor control device 11 according to a second embodiment will be described. The present embodiment basically has the same configuration as that of the first embodiment in FIG. 1 to FIG. 3 described above. Accordingly, members and configurations that are the same as those in the first embodiment will be denoted by the same signs as those therein, and detailed description thereof will be omitted.

The mechanical device 13 may be an electric power steering system. In this case, the motor 12 is an assisting motor. The assisting motor generates assisting torque that is applied to the steering mechanism of the vehicle. The assisting torque is a torque for assisting steering by the steering wheel. The steering mechanism includes a steering shaft connected to steering wheels, and a turning shaft that steers the steered wheels of the vehicle. The assisting torque is applied to the steering shaft or the turning shaft. The command value calculation unit 31 calculates the current command value I* for the assisting motor, in accordance with steering torque Tₕ detected by a torque sensor. The steering torque Tₕ is torque applied to the steering wheel. The steering torque Tₕ is a state variable S_{SV} indicating a steering state of the steering system.

The mechanical device 13 may be a steer-by-wire steering system. In this case, the motor 12 is a reaction force motor or a steering motor. The reaction force motor generates a steering reaction torque that is applied to the steering shaft of the vehicle. The steering reaction torque is a torque in an opposite direction of a steering direction of the steering wheel. The command value calculation unit 31 calculates the current command value I* for the reaction force motor, in accordance with the steering torque Tₕ detected by the torque sensor. The steering motor generates steering torque for steering the steered wheels of the vehicle. The command value calculation unit 31 calculates the current command value I* for the steering motor in accordance with a steering angle of the steering wheel. The steering angle is calculated, for example, based on the rotation angle θ of the motor 12 detected by the rotation angle sensor 12A. The steering torque Tₕ and the steering angle are the state variable S_{SV} indicating the steering state of the steering system.

In a case in which the motor 12 is an assist motor or a reaction motor, the motor control device 11 may be configured as follows.

That is to say, as indicated by the long dashed double-short dashed line in FIG. 2, the motor control device 11 has a compensator 34 and a multiplier 35. The compensator 34 calculates a torque differential value by differentiation of the steering torque Tₕ detected by the torque sensor, and calculates a compensation amount dT_{ca} for compensating for the effects of the disturbance T_{ld} in accordance with the torque differential value that is calculated. The multiplier 35 calculates a second correction value I_{c2} by multiplying the compensation amount dT_{ca} by the gain β. The second correction value I_{c2} is a current value. The subtractor 33C adds the second correction value I_{c2} to the current command value I*. This increases responsivity of the motor torque as to changes in the steering torque Tₕ. Thus, a smoother steering feel can be obtained. Also, advantages of suppressing disturbances, such as reverse input vibration from the steered wheels, brake vibrations generated due to brake operations, or the like, can also be obtained.

The compensator 34 is expressed by the following Expression (12). Expression (12) is a second-order differential equation.

$${α}_{2} ( t ) \cdot \{ ( {σ}^{2} / o {t}^{2} ) \cdot {x}_{0} ( t ) \} + {α}_{1} ( t ) \cdot \{ ( σ / σ t ) \cdot {x}_{0} ( t ) \} + {{α}_{0} ( t )}^{2} \cdot {x}_{0} ( t ) = {T}_{d} ( t ) \qquad ( 12 )$$

where “α₂” is a first coefficient. The first coefficient is a coefficient of the second-order differential term, which is the first term on the left side of Expression (12). “α₁” is a second coefficient. The second coefficient is a coefficient of the first-order differential term, which is the second term on the left side of Expression (12). “α₀” is a third coefficient. “t” is time. “x₀(t)” is the input to the compensator 34, which is the steering torque Tₕ here. “T_{d}” is the output of the compensator 34, which is the compensation amount dT_{ca} here.

In order to accommodate change in the frequency of the disturbance T_{ld} in conjunction with change in the angular velocity ωₘ of the motor 12, the first coefficient α₂, the second coefficient α₁, and the third coefficient do are set as expressed by the following Expressions (13) to (15).

$${α}_{2} ( t ) = 1 / {ω ( t )}^{2} \qquad ( 13 )$$

$${α}_{1} ( t ) = 2 \cdot α / ω ( t ) \qquad ( 14 )$$

$${α}_{0} ( t ) = 1 \qquad ( 15 )$$

where “t” is time. “ω(t)” is the frequency at time t, which may vary over time. “α” is the first parameter.

When the value of the frequency ω(t) of the disturbance T_{ld} changes in accordance with change in the angular velocity ωₘ of the motor 12, the value of the first coefficient α₂ and the value of the second coefficient α₁ change in accordance with the change. This enables the compensator 34 to perform compensation for the effects of disturbance T_{ld} over a broader frequency range.

However, there is a concern that, due to changing the value of the first coefficient α₂ and the value of the second coefficient α₁ in accordance with change in the frequency of the disturbance T_{ld}, torque fluctuation may be caused in the motor 12 other than those suppressing the disturbance T_{ld}.

Accordingly, in order to suppress torque fluctuation of the motor 12 due to change in the value of the first coefficient α₂ and the value of the second coefficient α₁ in accordance with change in the frequency of the disturbance T_{ld}, the second coefficient α₁ may be set as shown in the following Expression (16).

$${α}_{1} ( t ) = 2 \cdot α / ω ( t ) - {α}_{2} ( t ) \cdot ( d ω ( t ) / dt ) / ω ( t ) \qquad ( 16 )$$

where “t” is time. “ω(t)” is the frequency at time t, which may vary over time. “α” is the first parameter. “α₂(t)” is the first coefficient of the compensator 34 at time t.

The second term on the right side of Expression (16), “α₂(t)·(dω(t)/dt)/ω(t)”, is a correction term for the second coefficient α₁ of the compensator 34. The correction term is set based on the perspective of suppressing torque fluctuation of the motor 12 due to change in the value of the first coefficient α₂ and the value of the second coefficient α₁ of the compensator 34 in accordance with change in the frequency of the disturbance T_{ld}. When the frequency of the disturbance T_{ld} does not change, i.e., when the angular velocity ωₘ of the motor 12 is constant, the value of the correction term is “0”. When the frequency of the disturbance T_{ld} changes, i.e., when the angular velocity ωₘ of the motor 12 changes, the correction term becomes a value other than “0”, thereby correcting the value of the second coefficient α₁.

In this way, the compensator 34 corrects the value of the second coefficient α₁ in accordance with change in the frequency of the disturbance T_{ld} in conjunction with change in the angular velocity ωₘ of the motor 12. This enables torque fluctuations of the motor 12 other than those for suppressing the disturbance T_{ld}, due to changing the values of the coefficients (α₁, α₂) of the compensator 34 in accordance with change in the frequency of the disturbance T_{ld}, to be suppressed.

### <Effects of Second Embodiment>

The second embodiment has the following effects in addition to the effects in sections (1-1) to (1-6) of the first embodiment described above.

(2-1) The compensator 34 changes the value of the first coefficient α₂, which is the coefficient of the second-order differential term of the second-order differential equation representing the compensator 34, and the value of the second coefficient α₁, which is the coefficient of the first-order differential term, in accordance with change in the angular velocity ωₘ of the motor 12, and hence, in accordance with change in the frequency of the disturbance T_{ld}. This enables compensation for the effects of the disturbance T_{ld} over a broader frequency range. That is to say, even when the center frequency f_{c} of the disturbance T_{ld} to be eliminated fluctuates, the disturbance T_{ld} having the center frequency f_{c} that is fluctuating can be eliminated with pinpoint precision.

(2-2) When the angular velocity ωₘ of the motor 12 changes, the compensator 34 corrects the value of the second coefficient α₁ in order to suppress torque fluctuations of the motor 12 due to change in the value of the first coefficient α₂ and the value of the second coefficient α₁. The compensator 34 corrects the value of the second coefficient α₁ in accordance with change in the frequency of the disturbance T_{ld} in conjunction with change in the angular velocity ωₘ of the motor 12. This enables torque fluctuations of the motor 12 other than those for suppressing the disturbance T_{ld}, due to changing the values of the coefficients (α₁, α₂) of the compensator 34 in accordance with change in the frequency of the disturbance T_{ld}, to be suppressed. Accordingly, even when the values of the coefficients (α₁, α₂) of the compensator 34 are changed in accordance with change in the frequency of the disturbance T_{ld}, the effects of the disturbance T_{ld} can be compensated for as appropriate.

### Other Embodiments

The present embodiment may be carried out modified as follows.
As indicated by the long dashed double-short dashed lines in FIG. 2, the disturbance observer unit 33 may have a disturbance feedback controller 33D and an adder 33E. The disturbance feedback controller 33D takes in the differential value dT_{ld}\hat{ } of the estimated disturbance T_{ld}\hat{ } calculated by the estimator 33A, and calculates a third correction value I_{c3} based on the differential value dT_{ld}\hat{ } of the estimated disturbance T_{ld}—that is taken in. The third correction value I_{c3} is a current value corresponding to the estimated disturbance T_{ld}\hat{ } which is the difference between the actual motor output and the estimated motor output. The adder 33E calculates the final current command value I* by adding the third correction value I_{c3} to the current command value I* obtained after the effects of the disturbance _{ld} are compensated for. The feedback calculation unit 32 performs feedback control of the current supplied to the motor 12 based on the final current command value I*. Thus, the value of the current supplied to the motor 12 tracks the current command value I* more quickly.
In a case in which the mechanical device 13 is a steering system of a vehicle, and the motor 12 is an assisting motor or a reaction motor, the disturbance observer unit 33 may be configured as follows. That is to say, the disturbance observer unit 33 may stop disturbance compensation control, which is control for compensating for the effects of the disturbance T_{ld}, in a case of a state in which vibrations due to torque ripple of the motor 12 are unlikely to appear in the steering system. For example, vibrations due to torque ripple are easily conveyed to the steering system when the vehicle speed is an extremely low speed. Accordingly, the disturbance observer unit 33 may stop the disturbance compensation control when a value of the vehicle speed exceeds a vehicle speed threshold value. The speed threshold value is a reference for determining whether the vehicle speed is an extremely low speed. Also, vibrations due to torque ripple are easily conveyed to the steering system when the angular velocity ωₘ of the motor 12 is extremely slow. Accordingly, the disturbance observer unit 33 may stop the disturbance compensation control when the value of the angular velocity ωₘ exceeds an angular velocity threshold value. The angular velocity threshold value is a reference for when determining whether the angular velocity ωₘ of the motor 12 is extremely slow. The angular velocity ωₘ of the motor 12 reflects the steering speed of the steering wheel.
The motor control device 11 may have a function of detecting an abnormality in itself, an abnormality in the motor 12, or an abnormality in the mechanical device 13. In this case, the disturbance observer unit 33 may stop the disturbance compensation control when an abnormality in the motor control device 11, the motor 12, or the mechanical device 13, is detected. Executing compensation control when an abnormality is detected in the motor control device 11, the motor 12, or the mechanical device 13, is meaningless.
The command value calculation unit 31 may be configured as follows. That is to say, an arrangement may be made in which the command value calculation unit 31 calculates a torque command value based on the state variable S_{SV} indicating a state of the mechanical device 13, and calculates the current command value I* based on this torque command value that is calculated. The torque command value is torque that the motor 12 is to be caused to generate. In this case, the estimator 33A takes in the torque command value and the angular velocity ωₘ of the motor 12, which is the output of the plant P. The estimator 33A calculates the differential value dT_{ld}\hat{ } of the estimated disturbance T_{ld}\hat{ } based on the torque command value and the angular velocity ωₘ of the motor 12. The multiplier 33B calculates a torque correction value by multiplying the differential value dT_{ld}\hat{ } of the estimated disturbance T_{ld}\hat{ } by a predetermined gain. The torque correction value is a correction value for the torque command value. The subtractor 33C corrects the torque command value by subtracting the torque correction value from the torque command value. In this arrangement as well, the effects of the disturbance T_{ld} having the frequency that is the object of suppression can be compensated for.
The disturbance observer unit 33 may be configured as follows. That is to say, the disturbance observer unit 33 may calculate the difference between the rotation angle θ of the motor 12 obtained as the output of the plant P and the estimated rotation angle of the motor 12 obtained as the output of the nominal plant Pn, and compensate for the effects of the disturbance T_{ld} based on the difference value that is calculated in this way. The rotation angle θ of the motor 12 is rotation information of the motor 12.
The mechanical device 13 is not limited to being a vehicle steering system. The mechanical device 13 may be a machine tool driven by a motor, for example.

1. A motor control device, comprising:
a command value calculation unit configured to calculate a command value for controlling a motor of a mechanical device; and
a disturbance observer unit configured to estimate a disturbance applied to the mechanical device, based on the command value and rotation information of the motor, and to correct the command value based on the disturbance that is estimated, wherein
the disturbance observer unit has a parameter that is adjusted to compensate for effects of the disturbance having a specific frequency that is an object of suppression,
the disturbance that is applied to the mechanical device, after the effects of the disturbance have been compensated for, is a post-compensation disturbance,
the parameter is adjusted such that the post-compensation disturbance has frequency characteristics corresponding to antiresonance characteristics of the mechanical device, and
the disturbance observer unit is configured to change a value of the parameter in accordance with the rotation information of the motor.

2. The motor control device according to claim 1, wherein the rotation information of the motor is an angular velocity of the motor.

3. The motor control device according to claim 2, wherein:
the parameter includes a gain; and
the disturbance observer unit is configured to
calculate a differential value of the disturbance based on the command value and the angular velocity of the motor, and
calculate a first correction value for the command value by multiplying, by the gain, the differential value of the disturbance that is calculated.

4. The motor control device according to claim 3, wherein:
the parameter further includes a first observer gain and a second observer gain;
with “J” as an inertia coefficient of the mechanical device, “C” as a viscosity coefficient of the mechanical device, “s” as a Laplace operator, “L1” as the first observer gain, “L2” as the second observer gain, and “β” as the gain, the post-compensation disturbance has conveyance characteristics expressed by the following Expression (A)
$$\{ J {s}^{2} + ( - L 2 \cdot β + L 1 \cdot J ) s + L 2 \} / \{ {Js}^{2} + ( - L 2 \cdot C + L 1 \cdot J ) s + L 2 \} \cdot Js ; \qquad ( A )$$
and
the disturbance observer unit is configured to correct a value of the first observer gain when the angular velocity of the motor changes, in order to suppress torque fluctuations of the motor due to change in the value of the parameter.

5. The motor control device according to claim 4, wherein a value of the gain “β” is adjusted such that a value of the second term in the numerator of the Expression (A) is zero or close to zero.

6. The motor control device according to claim 3, wherein:
the mechanical device is configured to also operate due to torque being applied externally;
the motor control device further includes
a compensator configured to calculate a compensation amount for compensating for the effects of the disturbance in accordance with a differential value of torque externally applied to the mechanical device, and
a multiplier that calculates a second correction value for the command value by multiplying the compensation amount by the gain; and
the compensator is configured to change a value of a first coefficient, which is a coefficient of a second-order differential term of a second-order differential equation representing the compensator, and a value of a second coefficient, which is a coefficient of a first-order differential term, in accordance with the rotation information of the motor.

7. The motor control device according to claim 6, wherein the compensator is configured to correct the value of the second coefficient to suppress torque fluctuations of the motor due to change in the value of the first coefficient and the value of the second coefficient when the angular velocity of the motor changes.

8. The motor control device according to claim 2, wherein the disturbance observer is configured to
calculate the differential value of the disturbance based on the command value and the angular velocity of the motor, and
calculate a third correction value for the command value based on the differential value of the disturbance that is calculated.

9. The motor control device according to claim 1, wherein:
the mechanical device is a steering system of a vehicle; and
the motor generates torque that is applied to the steering system.
